(19) United States
(12) Patent Application Publication
(10) Pub. No.: US 2022/0091694 A1
(43) Pub. Date: Mar. 24, 2022

(54) FINGERPRINT IDENTIFICATION SYSTEM HAVING REAL/FAKE FINGERPRINT IDENTIFICATION FUNCTION FOR MOBILE PHONE, AND IDENTIFICATION METHOD USING SAME

(71) Applicant: Jilin QS Spectrum Data Technology Co. Ltd, Changchun (CN)

(72) Inventors: Yu REN, Changchun (CN); Hongxing CAI, Changchun (CN); Shuo WANG, Changchun (CN); Yongsheng ZHANG, Changchun (CN); Weili TANG, Changchun (CN); Zhihai YAO, Changchun (CN); Yanxu DUANMU, Changchun (CN); Pengbo ZHANG, Changchun (CN)

(21) Appl. No.: 17/544,243

(22) Filed: Dec. 7, 2021

Related U.S. Application Data
(63) Continuation of application No. PCT/CN2021/096704, filed on May 28, 2021.

(51) Int. Cl. G06F 3/042; G06F 3/041; G06K 9/00

(52) U.S. Cl. CPC G06F 3/0421; G06F 3/0416; G06K 9/0004; G06K 9/00114; G06K 9/00087

(57) ABSTRACT

A fingerprint identification system for a mobile phone and an identification method. The system includes a fingerprint collection module, a spectral chip, a data storage module and an identification module. The fingerprint collection module is arranged under a mobile phone screen. The mobile phone screen provides a light source to illuminate a fingerprint. The spectral chip is configured to modulate an incident spectrum, and convert an optical signal into an electrical signal to be amplified and converted into a digital signal or code for output. A finger reflection spectral data and a fingerprint image data are collected by inversion of an optical signal intensity information and a pixel location information. The data storage module is configured to store reflection spectral data and fingerprint image data of a real finger input in advance. The identification module is configured to compare the collected data with the pre-stored data.

### CROSS-REFERENCE TO RELATED APPLICATIONS

This application is a continuation of International Patent Application PCT/CN2021/096704, filed on May 28, 2021, which claims the benefit of priority from Chinese patent applications No. 202010240921.0, filed on Mar. 31, 2020. The content of the aforementioned application, including any intervening amendments thereto, is incorporated herein by reference.

### TECHNICAL FIELD

The present application relates to optical fingerprint identification technologies, and more particularly to a fingerprint identification system having a real/fake fingerprint identification function for a mobile phone, and an identification method using the same.

### BACKGROUND

As mobile phones are gradually becoming a collection of personal information, fingerprint identification, as a highly-secure unlocking mode, has been applied in mobile phones. At present, the mobile phone fingerprint identification mainly includes capacitive fingerprint identification, ultrasonic fingerprint identification and under-screen optical fingerprint identification. Regarding the under-screen optical fingerprint identification, a complementary metal oxide semiconductor (CMOS) sensor is employed to obtain the reflected image of the fingerprint under the irradiation of a strong light passing through a small hole array, and the fingerprint image is read according to the light on a photosensitive module to complete the fingerprint identification and unlocking (Pengfei, Li & Meijun, Dan, Concept, Technology and Development of Under-Screen Fingerprint Identification[J]. Patent Examination Collaboration Center (Beijing) of the Patent Office of the State Intellectual Property Office, Optoelectronics Department, 2018). Considering that the fingerprint identification technology is only limited to the use of image information, the only way to improve the identification security is to increase the accuracy of the detector. However, this method not only increases the complexity of the overall wiring of the fingerprint recognition system of the mobile phone, but also raises higher requirements for the production process. Especially when the image features of the detected objects are highly similar, the accuracy of the pattern recognition is too low to meet the actual application requirements. Therefore, it is necessary to develop a new fingerprint identification system and method.

### SUMMARY

Based on this, an object of the present disclosure is to provide a fingerprint identification system having a real/fake fingerprint identification function for a mobile phone. During the fingerprint identification, the system can identify whether the fingerprint to be identified is derived from a real human finger based on spectral data, and can also identify the fingerprint information based on image data. The double identification can effectively ensure the accuracy of fingerprint identification and improve the security of the fingerprint identification.

Technical solutions of the present disclosure are described as follows.

In a first aspect, this application provides a fingerprint identification system having a real/fake fingerprint identification function for a mobile phone, comprising:

a fingerprint collection module;

a spectral chip;

a data storage module; and

an identification module;

wherein the fingerprint collection module is arranged under a screen of the mobile phone; the screen of the mobile phone provides a light source with three primary color bands of red, blue and green to illuminate a fingerprint to be identified during fingerprint collection; and after illumination, a light reflected by a finger forms an incident light of the spectral chip;

the spectral chip is arranged inside the mobile phone; the spectral chip is configured to modulate a spectrum of the incident light, and convert an optical signal into an electrical signal to be amplified and converted by analog-to-digital conversion into a digital signal or a code for output; meanwhile, according to an intensity information of an output optical signal and a location information of a corresponding pixel, an inversion of a spectral data of the light reflected by the finger and a fingerprint image data is performed;

the data storage module is electrically connected to the spectral chip, and is configured to store a real finger reflection spectral data and a real fingerprint image data inputted in advance; and

the identification module is configured to compare the spectral data and the fingerprint image data collected by the spectral chip respectively with the real finger reflection spectral data and the real fingerprint image data pre-stored in the data storage module; and when the spectral data and the fingerprint image data collected by the spectral chip respectively match with the real finger reflection spectral data and the real fingerprint image data pre-stored in the data storage module, the mobile phone is unlocked.

In an embodiment, the spectral chip comprises a spectrum modulation module and an image and spectrum inversion module; the spectrum modulation module is configured to modulate a spectrum of the incident light and convert the optical signal into the electrical signal to be amplified and converted by the analog-to-digital conversion into the digital signal or the code for output; and

the image and spectrum inversion module is electrically connected to the spectrum modulation module, and is configured to collect the spectral data of the light reflected by the finger and the fingerprint image data by inversion according to the intensity information of the optical signal and the location information of the corresponding pixel output from the spectrum modulation module.

In an embodiment, the identification module is configured to adopt a distance calculation method or a discrimination test method for identification; and the distance calculation method comprises a Euclidean distance method and a similar information clustering method.

In an embodiment, the spectrum modulation module comprises a photoelectric conversion substrate and a light-filtering film arranged on the photoelectric conversion substrate;

the photoelectric conversion substrate is configured to convert the optical signal into the electrical signal to be converted into the digital signal or the code for output; the light-filtering film is configured to distinguish the spectrum of the incident light spectrum; the light-filtering film has a single-layer structure, which is spliced by N kinds of known materials with different light transmittances through coating and etching in sequence; the light-filtering film comprises N periods; each of the N periods represents a channel and comprises n units, respectively T₁, T₂ . . . Tₙ; each of the N units is configured to cover M pixels on the photoelectric conversion substrate, wherein M is greater than or equal to 1; a periodic structure formed by all units covers all pixels on the photoelectric conversion substrate; the light-filtering film corresponding to each pixel has the same or different spectral transmittances to enable spectroscopic operation; the spectral transmittances of the light-filtering film are all known; and an optical signal intensity on each pixel is corrected based on a corresponding spectral transmittance information, and the fingerprint image data is collected by inversion in combination with a combination of all pixels.

In an embodiment, the image and spectrum inversion module is configured to perform inversion through steps of:

correcting an optical signal intensity on each pixel by dividing the optical signal intensity value on each pixel by a corresponding spectral transmission value; and

combining a combination of all pixels to inverse the fingerprint image data to achieve a high-accuracy imaging function;

wherein a spectral transmission value corresponding to each pixel is known; in a periodic structure formed by N pixels, according to a spectral transmittance curve and a combination of the N pixels, an incident spectral values of N pixels is inversed, as shown in formula (3):

Sᵢ∫I(λ)Tᵢ(λ)η(λ)dλ, (3);

wherein S is an optical signal intensity value output by the photoelectric conversion substrate; I is an incident spectrum, which is a signal to be solved; T is a spectral transmittance of the light-filtering film; η is a quantum efficiency of the photoelectric conversion substrate; and λ is an incident wavelength.

In an embodiment, the photoelectric conversion substrate is a silicon-based image sensor, specifically, a CMOS image sensor or a CCD image sensor.

In an embodiment, the spectrum modulation module is produced through steps of:

(S1) selecting a suitable photoelectric conversion substrate according to a usage scenario; and

(S2) selecting N kinds of light-filtering film materials with different light transmittances; coating a first kind of light-filtering film material on the photoelectric conversion substrate followed by coating an etching layer to etch an area unneeded to be coated with the first light-filtering film material according to a corresponding pixel on the photoelectric conversion substrate; coating a second light-filtering film material on the photoelectric conversion substrate followed by coating another etching layer to etch an area unneeded to be coated with the second light-filtering film material according to a corresponding pixel on the photoelectric conversion substrate; and so on until the N kinds of light-filtering film materials are all coated on the photoelectric conversion substrate to form a light-filtering film; the light-filtering film has a single-layer structure with N periods; each period comprises N units, respectively T₁, T₂ . . . Tₙ; and each unit is configured to cover M pixels on the photoelectric conversion substrate, wherein M is greater than or equal to 1; and the light-filtering film corresponding to each pixel has the same or different spectral transmittances.

In a second aspect, this disclosure provides a fingerprint identification method using the fingerprint identification system, comprising:

(S1) starting a fingerprint identification function of the mobile phone to allow the fingerprint identification system of the mobile phone to start self-checking; and after the fingerprint identification system is confirmed to be normal by self-checking, allowing the spectral chip, the identification module, and the data storage module to be in a warm-up standby state;

(S2) allowing a fingerprint to be identified to press the fingerprint collection module on the screen of the mobile phone; emitting, by the light source with three primary color bands, light waves to illuminate the fingerprint to be identified to form a reflected light on the surface of the fingerprint to be identified;

(S3) starting the spectral chip; allowing the reflected light to enter the spectral chip to be split by the spectrum modulation module of the spectral chip; converting an optical signal of a split light into an electrical signal, and subjecting the electrical signal to amplification and analog-to-digital conversion to generate a digital signal or a code for output; and performing, by the image and spectrum inversion module, an inversion according to an intensity information of an optical signal output by the spectrum modulation module and a location information of a corresponding pixel to obtain a finger spectral data and a fingerprint image data;

wherein the image and spectrum inversion module performs the inversion through steps of:

combining a combination of all pixels to inverse the fingerprint image data to achieve high-accuracy imaging;

wherein a spectral transmission value corresponding to each pixel is known; in a periodic structure formed by N pixels, according to a spectral transmittance curve and a combination of the N pixels, an incident spectral value of the N pixels is inversed, as shown in formula (3):

$${S}_{i} = \int I ( λ ) {T}_{i} ( λ ) η ( λ ) d λ , \qquad ( 3 ) ;$$

wherein S is an optical signal intensity value output by the photoelectric conversion substrate; I is an incident spectrum, which is a signal to be solved; T is a spectral transmittance of the light-filtering film; η is a quantum efficiency of the photoelectric conversion substrate; and λ is an incident wavelength.

(S4) inputting the obtained finger spectral data and fingerprint image data into the identification module; comparing, by the identification module, the obtained finger spectral data and fingerprint image data respectively with a real finger reflection spectral data and a real fingerprint image data pre-stored in the data storage module; wherein if the obtained finger spectral data and fingerprint image data respectively matches with the real finger reflection spectral data and the real fingerprint image data pre-stored in the data storage module, the fingerprint to be identified is identified as a real fingerprint.

Compared to the prior art, the present disclosure has the following beneficial effects.

(1) The fingerprint identification system provided herein integrates image and spectral data to identify whether the fingerprint is real or fake, which realizes an accurate fingerprint identification, greatly improves the security of the mobile phone, and effectively prevents the mobile phone from being unlocked by a fake fingerprint imitated using silica gel. Moreover, the spectroscopic method can realize the rapid and accurate fingerprint identification.

(2) In the fingerprint identification system provided by the present disclosure, the spectrum modulation module in the spectral chip has a single-layered structure, which has simple structure, small size, small thickness (micron dimension) and light weight, and has a high spectral resolution and spatial resolution, high accuracy and fast detection. Moreover, it can be integrated in the existing mobile phone to realize the extraction of the spectrum and a high-accuracy imaging function such that the extracted fingerprint is clearer and more accurate.

(3) The identification method provided by the present disclosure integrates image and spectral data to achieve a more accurate fingerprint identification. A light source with three primary color bands is used to illuminate the finger and the spectral chip can collect a reflection spectrum and fingerprint image information of human skin. In combination with a data processing system, this method realizes the low-cost and convenient fingerprint identification.

### BRIEF DESCRIPTION OF THE DRAWINGS

To render the objects and technical solutions of the present disclosure clearer, the present disclosure will be described below with reference to the drawings.

FIG. 1 schematically shows a fingerprint identification system for a mobile phone according to an embodiment of the disclosure;

FIG. 2 schematically shows a spectrum modulation module according to an embodiment of the disclosure;

FIG. 3 is a flow chart of a mobile phone fingerprint identification method according to an embodiment of the disclosure;

FIG. 4a shows a reflection spectrum of a finger under red, blue and green light irradiation; and

FIG. 4b shows a reflection spectrum of a false fingerprint film under red, blue and green light irradiation.

### DETAILED DESCRIPTION OF EMBODIMENTS

In the following description, many specific details are described to provide a comprehensive understanding of one or more embodiments of the disclosure. However, it should be understood that these embodiments can also be implemented without these specific details. In other cases, the well-known structure and equipment are shown in block diagrams to facilitate the description of one or more embodiments.

### Embodiment 1 Mobile Phone Fingerprint Identification System

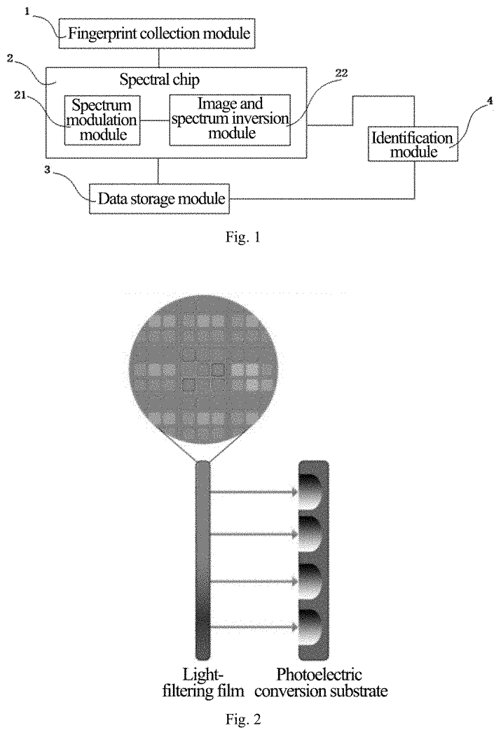

Referring to an embodiment shown in FIG. 1, a mobile phone fingerprint identification system having a real/fake fingerprint identification function includes a fingerprint collection module 1, a spectral chip 2, a data storage module 3 and an identification module 4. The fingerprint collection module 1 is arranged under a screen of the mobile phone. The screen of the mobile phone screen provides a light source with three primary color bands of red (the central wavelength is 630 nm), blue, (the central wavelength is 460 nm) and green (the central wavelength is 520 nm) to illuminate a fingerprint to be identified during fingerprint collection. After illumination, a light reflected by a finger forms an incident light of the spectral chip.

The spectral chip 2 (product name: hyperspectral pixel coating chip; model specification: QS-A-8-400-001; size: 4.5 mm×4.5 mm; thickness: 100 μm; spectral range: 200 nm-1100 nm; spectral resolution: 10 nm; data acquisition time: 1 ms) is arranged inside the mobile phone. The spectral chip is configured to modulate spectrum of the incident light, and convert an optical signal into an electrical signal to be amplified and converted by analog-to-digital conversion into a digital signal or a code for output. Meanwhile, according to an intensity information of an output optical signal and a location information of a corresponding pixel, an inversion of a spectral data of the light reflected by the finger and a fingerprint image data is performed.

The data storage module 3 is electrically connected to the spectral chip 2, and is configured to store a real finger reflection spectral data and a real fingerprint image data inputted in advance.

The identification module 4 is configured to compare spectral data and the fingerprint image data collected by the spectral chip respectively with the real finger reflection spectral data and the real fingerprint image data pre-stored in the data storage module; and when the spectral data and the fingerprint image data collected by the spectral chip respectively match with the real finger reflection spectral data and the real fingerprint image data pre-stored in the data storage module, the mobile phone is unlocked.

### Embodiment (2) Mobile Phone Fingerprint Identification System

Referring to an embodiment shown in FIG. 1, a mobile phone fingerprint identification system provided herein differs from that of Embodiment 1 in the spectral chip. The spectral chip 2 in Embodiment 2 includes a spectrum modulation module 21 and an image and spectrum inversion module 22. The spectrum modulation module 21 includes a photoelectric conversion substrate and a light-filtering film arranged on the photoelectric conversion substrate. The photoelectric conversion substrate is a silicon-based image sensor, specifically, a CMOS image sensor or a charge-coupled device (CCD) image sensor. The photoelectric conversion substrate is configured to convert the optical signal into the electrical signal to be converted into the digital signal or the code for output. The light intensity information at each pixel position is output, that is, there is a one-to-one correspondence between the output light intensity information and pixel position information. The light-filtering film has a single-layer structure, which is spliced by N kinds of known materials with different light transmittances through coating and etching in sequence. The light-filtering film includes N periods. Each of the N periods represents a channel, and includes n units, respectively T₁, T₂ . . . Tₙ. Each of the N units is configured to cover M pixels on the photoelectric conversion substrate, where M is greater than or equal to 1. A periodic structure formed by all the units covers all pixels on the photoelectric conversion substrate. The light-filtering film corresponding to each pixel has the same or different spectral transmittances to enable spectroscopic operation. In addition, the spectral transmittances of the light-filtering film are all known. An optical signal intensity on each pixel is corrected based on a corresponding spectral transmittance information, and the fingerprint image data is collected by inversion in combination with a combination of all pixels.

The image and spectrum inversion module is electrically connected to the spectrum modulation module, and is configured to collect the spectral data of the light reflected by the finger and the fingerprint image data by inversion according to the intensity information of the optical signal and the location information of the corresponding pixel output from the spectrum modulation module.

The image and spectrum inversion module is configured to perform inversion through the following steps.

An optical signal intensity on each pixel is corrected by dividing the optical signal intensity value on each pixel by a corresponding spectral transmission value. All pixels are combined to inverse the fingerprint image data to achieve high-accuracy imaging. A spectral transmission value corresponding to each pixel is known, in a periodic structure formed by N pixels, according to a spectral transmittance curve and a combination of the N pixels, an incident spectral values of the N pixels is inversed, as shown in the following formula:

$${S}_{i} = \int I ( λ ) {T}_{i} ( λ ) η ( λ ) d λ ,$$

where S is an optical signal intensity value output by the photoelectric conversion substrate; I is an incident spectrum, which is a signal to be solved; T is a spectral transmittance of the light-filtering film; η is a quantum efficiency of the photoelectric conversion substrate; and λ is an incident wavelength.

The identification module is configured to adopt a distance calculation method for identification. The distance calculation method includes a Euclidean distance method and a similar information clustering method, or a discrimination test method to distinguish whether it is the same finger. During the identification by using the discrimination test method, a finger is tested once every 20-60 ms. 10 average spectral data of the same finger are taken as benchmark spectral data and stored in the data storage module. When a fingerprint is unlocking, the collected fingerprint spectrum is directly compared with the reference spectra data. If the maximum discrimination of multiple measurements is less than 2.38, it can be considered as the same finger.

### Embodiment (3) a Method for Producing the Spectrum Inversion Module

Provided herein is a method for producing the spectrum inversion module, which is described below.

(S1) A suitable photoelectric conversion substrate is selected according to a usage scenario.

(S2) N kinds of light-filtering film materials with different light transmittances are selected. A first light-filtering film material is coated on the photoelectric conversion substrate followed by coating an etching layer to etch an area unneeded to be coated with the first light-filtering film material according to a corresponding pixel on the photoelectric conversion substrate. A second light-filtering film material is coated on the photoelectric conversion substrate followed by coating another etching layer to etch an area unneeded to be coated with the second light-filtering film material according to a corresponding pixel on the photoelectric conversion substrate. The above steps are repeated successively until the N kinds of light-filtering film materials are all coated on the photoelectric conversion substrate to form a light-filtering film. The light-filtering film has a single-layer structure with N periods. Each period includes n units, respectively T₁, T₂ . . . Tₙ. Each unit is configured to cover M pixels on the photoelectric conversion substrate, where M is greater than or equal to 1. The light-filtering film corresponding to each pixel has the same or different spectral transmittances.

In this embodiment, the etching process in step (S2) can be completed by a direct laser writing etching method, a mask lithography method, an ion beam etching method, and an electron beam etching method, etc. When the mask lithography etching method is used, each kind of light-filtering film material is coated with a layer of photoresist, followed by exposure, development, baking, etching, post-drying, and other standard lithography processes to complete etching. When the direct laser writing etching method, the ion beam etching method and the electron beam etching method are used, the preparation process is similar to that in the mask lithography etching method, using the existing method for etching.

In this embodiment, the light-filtering film is made of a polyimide-based material.

### Embodiment (4) a Fingerprint Identification Method Using the Fingerprint Identification System

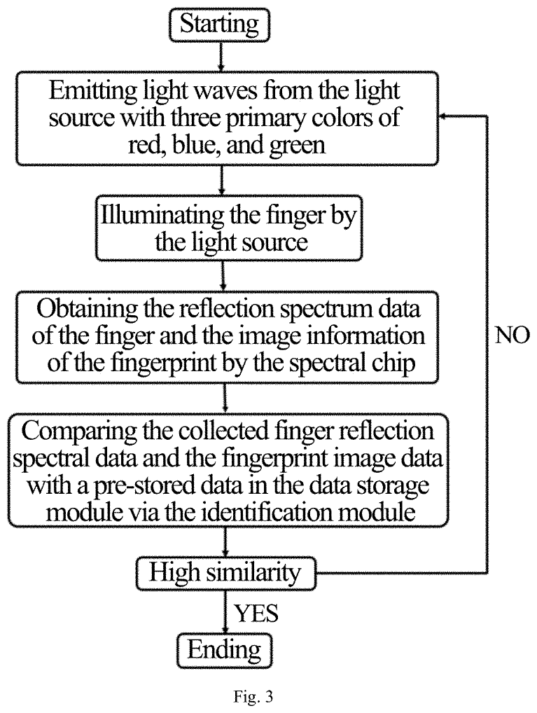

As shown in FIG. 3, a fingerprint identification method using the fingerprint identification system is provided in an embodiment, which is described below.

(S1) A fingerprint identification function of the mobile phone is started to allow the fingerprint identification system of the mobile phone to start self-checking. After the fingerprint identification system is confirmed to be normal by self-checking, the spectral chip, the identification module, and the data storage module are allowed to be in a warm-up standby state.

(S2) A fingerprint to be identified is allowed to press the fingerprint collection module on the screen of the mobile phone. Light waves emitted by the light source with three primary color bands illuminate the fingerprint to be identified to form a reflected light on the surface of the fingerprint to be identified.

(S3) The spectral chip is started. The reflected light enters the spectral chip to be split by the spectrum modulation module of the spectral chip. An optical signal of the split light is converted into an electrical signal to be amplified and converted into a digital signal or a code for output. Then the image and spectrum inversion module obtains a finger reflection spectral data and a fingerprint image data by an inversion according to an intensity information of an optical signal and a corresponding pixel location information output by the spectrum modulation module.

The image and spectrum inversion module performs the inversion through the following steps.

An optical signal intensity on each pixel is corrected by dividing the optical signal intensity value on each pixel by a corresponding spectral transmission value. All pixels are combined to inverse the fingerprint image data to achieve high-accuracy imaging. A spectral transmission value corresponding to each pixel is known, in a periodic structure formed by the N pixels, according to a spectral transmittance curve and a combination of the N pixels, an incident spectral values of the N pixels is inversed, as shown in the following formula:

$${S}_{i} = \int I ( λ ) {T}_{i} ( λ ) η ( λ ) d λ ,$$

where S is an optical signal intensity value output by the photoelectric conversion substrate; I is an incident spectrum, which is a signal to be solved; T is a spectral transmittance of the light-filtering film; η is a quantum efficiency of the photoelectric conversion substrate; and λ is an incident wavelength.

(S4) The obtained finger spectral data and fingerprint image data are inputted into the identification module. The obtained finger spectral data and fingerprint image data are respectively compared with a real finger reflection spectral data and a real fingerprint image data pre-stored in the data storage module and the collected. If the obtained finger spectral data and fingerprint image data respectively matches with the real finger reflection spectral data and the real fingerprint image data pre-stored in the data storage module, the fingerprint to be identified is identified as a real fingerprint.

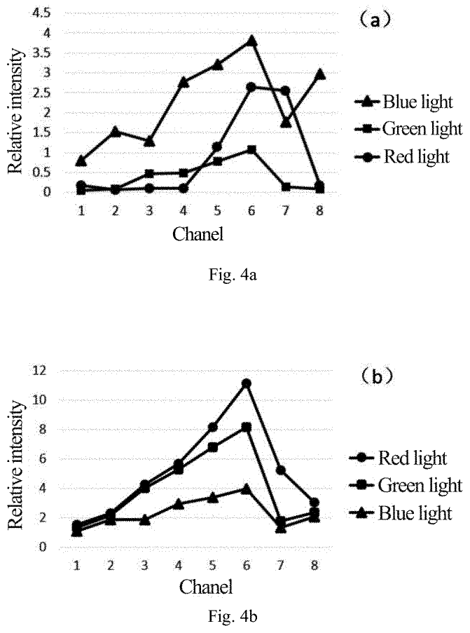

In this disclosure, the spectral chip in Embodiment 1 is implemented to measure the reflection spectra of a real fingerprint and a false fingerprint film engraved with the real fingerprint. The specific spectra are shown in FIG. 4, where FIG. 4a is the reflection spectrum of the finger under red, blue and green light irradiation; and FIG. 4b is the reflection spectrum of the false fingerprint film under red, blue and green light irradiation. As can be seen from the FIG. 4, even if the fingerprints are same, as the real finger is different from the false fingerprint film, the reflection spectrum of the finger is completely different from that of the false fingerprint film. Therefore, the reflection spectral information can be used to accurately identify whether the fingerprint is real, preventing others from using fake fingerprints to unlock the mobile phone.

Described above are only preferred embodiments of the present disclosure, which are not intended to limit the scope of the present disclosure. Any replacements and changes made by those skilled in the art without departing from the scope of the disclosure shall fall within the scope of the disclosure defined by the appended claims.

What is claimed is:

1. A fingerprint identification system having a real/fake fingerprint identification function for a mobile phone, comprising:
a fingerprint collection module;
a spectral chip;
a data storage module; and
an identification module;
wherein the fingerprint collection module is arranged under a screen of the mobile phone; the screen of the mobile phone provides a light source with three primary color bands of red, blue and green to illuminate a fingerprint to be identified during fingerprint collection; and after illumination, a light reflected by a finger forms an incident light of the spectral chip;
the spectral chip is arranged inside the mobile phone; the spectral chip is configured to modulate a spectrum of the incident light, and convert an optical signal into an electrical signal to be amplified and converted by analog-to-digital conversion into a digital signal or a code for output; meanwhile, according to an intensity information of an output optical signal and a location information of a corresponding pixel, an inversion of a spectral data of the light reflected by the finger and a fingerprint image data is performed;
the data storage module is electrically connected to the spectral chip, and is configured to store a real finger reflection spectral data and a real fingerprint image data inputted in advance; and
the identification module is configured to compare the spectral data and the fingerprint image data collected by the spectral chip respectively with the real finger reflection spectral data and the real fingerprint image data pre-stored in the data storage module; and when the spectral data and the fingerprint image data collected by the spectral chip respectively match with the real finger reflection spectral data and the real fingerprint image data pre-stored in the data storage module, the mobile phone is unlocked.

2. The fingerprint identification system of claim 1, wherein the spectral chip comprises a spectrum modulation module and an image and spectrum inversion module; the spectrum modulation module is configured to modulate a spectrum of the incident light and convert the optical signal into the electrical signal to be amplified and converted by the analog-to-digital conversion into the digital signal or the code for output; and
the image and spectrum inversion module is electrically connected to the spectrum modulation module, and is configured to collect the spectral data of the light reflected by the finger and the fingerprint image data by inversion according to the intensity information of the optical signal and the location information of the corresponding pixel output from the spectrum modulation module.

3. The fingerprint identification system of claim 1, wherein the identification module is configured to adopt a distance calculation method or a discrimination test method for identification; and the distance calculation method comprises a Euclidean distance method and a similar information clustering method.

4. The fingerprint identification system of claim 2, wherein the spectrum modulation module comprises a photoelectric conversion substrate and a light-filtering film arranged on the photoelectric conversion substrate;
the photoelectric conversion substrate is configured to convert the optical signal into the electrical signal to be converted into the digital signal or the code for output; the light-filtering film is configured to distinguish the spectrum of the incident light; the light-filtering film has a single-layer structure, which is spliced by N kinds of known materials with different light transmittances through coating and etching in sequence; the light-filtering film comprises N periods; each of the N periods represents a channel, and comprises n units, respectively T₁, T₂ . . . Tₙ; each of the N units is configured to cover M pixels on the photoelectric conversion substrate, wherein M is greater than or equal to 1; a periodic structure formed by all units covers all pixels on the photoelectric conversion substrate; the light-filtering film corresponding to each pixel has the same or different spectral transmittances to enable spectroscopic operation; the spectral transmittances of the light-filtering film are all known; and an optical signal intensity on each pixel is corrected based on a corresponding spectral transmittance information, and the fingerprint image data is collected by inversion in combination with a combination of all pixels.

5. The fingerprint identification system of claim 4, wherein the image and spectrum inversion module is configured to perform inversion through steps of:
correcting an optical signal intensity on each pixel by dividing the optical signal intensity value on each pixel by a corresponding spectral transmission value; and
combining a combination of all pixels to inverse the fingerprint image data to achieve high-accuracy imaging;
wherein a spectral transmission value corresponding to each pixel is known; in a periodic structure formed by N pixels, according to a spectral transmittance curve and a combination of the N pixels, an incident spectral value of the N pixels is inversed, as shown in formula (3):
$${S}_{i} = \int I ( λ ) {T}_{i} ( λ ) η ( λ ) d λ , \qquad ( 3 ) ;$$
wherein S is an optical signal intensity value output by the photoelectric conversion substrate; I is an incident spectrum, which is a signal to be solved; T is a spectral transmittance of the light-filtering film; η is a quantum efficiency of the photoelectric conversion substrate; and λ is an incident wavelength.

6. The fingerprint identification system of claim 2, wherein the spectrum modulation module is produced through steps of:
(S1) selecting a suitable photoelectric conversion substrate according to a usage scenario; and
(S2) selecting N kinds of light-filtering film materials with different light transmittances; coating a first light-filtering film material on the photoelectric conversion substrate followed by coating an etching layer to etch an area unneeded to be coated with the first light-filtering film material according to a corresponding pixel on the photoelectric conversion substrate; coating a second light-filtering film material on the photoelectric conversion substrate followed by coating another etching layer to etch an area unneeded to be coated with the second light-filtering film material according to a corresponding pixel on the photoelectric conversion substrate, and so on until the N kinds of light-filtering film materials are all coated on the photoelectric conversion substrate to form a light-filtering film; the light-filtering film has a single-layer structure with N periods; each period comprises N units, respectively T₁, T₂ . . . Tₙ; and each unit is configured to cover M pixels on the photoelectric conversion substrate, wherein M is greater than or equal to 1; and the light-filtering film corresponding to each pixel has the same or different spectral transmittances.

7. A fingerprint identification method using the fingerprint identification system of claim 4, comprising:
(S1) starting a fingerprint identification function of the mobile phone to allow the fingerprint identification system of the mobile phone to start self-checking; and after the fingerprint identification system is confirmed to be normal by self-checking, allowing the spectral chip, the identification module, and the data storage module to be in a warm-up standby state;
(S2) allowing a fingerprint to be identified to press the fingerprint collection module on the screen of the mobile phone; emitting, by the light source with three primary color bands, light waves to illuminate the fingerprint to be identified to form a reflected light on the surface of the fingerprint to be identified;
(S3) starting the spectral chip; allowing the reflected light to enter the spectral chip to be split by the spectrum modulation module of the spectral chip; converting an optical signal of a split light into an electrical signal, and subjecting the electrical signal to amplification and analog-to-digital conversion to generate a digital signal or a code for output; and performing, by the image and spectrum inversion module, an inversion according to an intensity information of an optical signal output by the spectrum modulation module and a location information of a corresponding pixel to obtain a finger spectral data and a fingerprint image data;
wherein the image and spectrum inversion module performs the inversion through steps of:
combining a combination of all pixels to inverse the fingerprint image data to achieve high-accuracy imaging;
wherein a spectral transmission value corresponding to each pixel is known; in a periodic structure formed by N pixels, according to a spectral transmittance curve and a combination of the N pixels, an incident spectral value of the N pixels is inversed, as shown in formula (3):
$${S}_{i} = \int I ( λ ) {T}_{i} ( λ ) η ( λ ) d λ , \qquad ( 3 ) ;$$
wherein S is an optical signal intensity value output by the photoelectric conversion substrate; I is an incident spectrum, which is a signal to be solved; T is a spectral transmittance of the light-filtering film; η is a quantum efficiency of the photoelectric conversion substrate; and λ is an incident wavelength; and
(S4) inputting the obtained finger spectral data and fingerprint image data into the identification module; comparing, by the identification module, the obtained finger spectral data and fingerprint image data respectively with a real finger reflection spectral data and a real fingerprint image data pre-stored in the data storage module; wherein if the obtained finger spectral data and fingerprint image data respectively matches with the real finger reflection spectral data and the real fingerprint image data pre-stored in the data storage module, the fingerprint to be identified is identified as a real fingerprint.
